(19) United States
(12) Patent Application Publication
(10) Pub. No.: US 2005/0243674 A1
(43) Pub. Date: Nov. 3, 2005

(54) Optical pickup, optical information processing apparatus and optical information processing method

(76) Inventor: Hideaki Hirai, Kanagawa (JP)

Correspondence Address: DICKSTEIN SHAPIRO MORIN & OSHINSKY LLP, 2101 L Street, NW, Washington, DC, 20037, US

(21) Appl. No.: 11/038,524

(22) Filed: Jan. 21, 2005

(30) Foreign Application Priority Data
Jan. 22, 2004 (JP) NO. 2004-014721

(51) Int. Cl. G11B 7/00

(52) U.S. Cl. 369/53.23

(57) ABSTRACT

In a case where the optical recording medium comprises a multi-layer optical recording medium having a plurality of information recording surfaces, the following equation is satisfied on each information recording surface x (x=1, 2, . . . ) of the multi-layer optical recording medium: |CLx/CDx|≧1, where CDx (x=1, 2, . . . ) denotes each least squire error value (unit: λrms) of a cubic coma aberration component occurring per unit angle when the multi-layer optical recording medium is inclined; and CLx (x=1, 2, . . . ) denotes each least squire error value (unit: λrms) of a cubic coma aberration component occurring per unit angle when the objective lens is inclined in a case where the laser light is condensed and applied to a predetermined information recording surface x of the multi-layer optical recording medium.

### BACKGROUND OF THE INVENTION

1. Field of the Invention

The present invention relates to an optical pickup, an optical information processing apparatus and an optical information processing method.

2. Description of the Related Art

As a means for storing video information, audio information or data for a computer, an optical recording medium such as a CD having a recording capacity of 0.65 GB, a DVD having a recording capacity of 4.7 GB or such is spreading. Recently, further improvement of a recording density and increase in a recording capacity is strongly demanded.

Specifically, BS digital broad casting and further ground-based digital broad casting have started, and, there is a request to record an HDTV program in an optical recording medium. However, when a conventional DVD-type optical recording medium is applied, it is possible to record such video and audio information for merely on the order of 20 minutes at most. Therefore, an optical recording medium having a capacity more than 22 GB and optical information processing apparatus by which such video and audio information can be recorded for more than two hours is requested.

As a means for increasing the recording density of the optical recording medium, it is effective to reduce a diameter of a beam spot produced on the optical recording medium as a result of condensing the light beam by an objective lens, by increasing a numerical aperture (NA) of the objective lens or shortening a wavelength of a light source in the optical information processing apparatus, by which information is written to or read out from the optical recording medium. For example, in a case of the CD-type optical recording medium, the numerical aperture NA of the objective lens is prescribed as being 0.50 and the wavelength of the light source is prescribed as being 780 nm. On the other hand, for the DVD-type recording medium for which the recording density is improved in comparison to the CD-type recording medium, the numerical aperture NA of the objective lens is prescribed as being 0.65 and the wavelength of the light source is prescribed as being 660 nm. As described above, improvement of the recording density and increase in the recording capacity are demanded for the optical recording medium. For this purpose, it is demanded to further increase the numerical aperture NA of the objective lens from 0.65 and further shorten the wavelength of the light source from 660 nm.

As another method, as disclosed in Japanese Laid-open Patent Applications Nos. 8-96406 and 9-54981, a multi-layer optical recording medium, in which a plurality of, for example, two information recording surfaces are placed on one another, may be applied. For example, by sticking two injection-molded substrates in such a manner that signal surfaces thereof may face one another, it is possible to achieve a double-layer optical recording medium having a recording capacity twice that of a single-layer optical recording medium.

### SUMMARY OF THE INVENTION

Generally speaking, as mentioned above, the double-layer optical recording medium has a configuration in which the two injection-molded substrates are stuck in such a manner that the signal surfaces thereof may face one another. In this configuration, a first layer from the reading side (the light source side) is referred to as a layer 0 (simply referred to as a L0, hereinafter) and a second layer is referred to as a layer 1 (simply referred to as a L1, hereinafter). Between these layers L0 and L1, commonly, a layer called an intermediate layer is inserted (see FIG. 9). By inserting the intermediate layer, it is possible to achieve signal separation between the layers L0 and L1. An objective lens is designed optimally in such a manner that spherical aberration may be minimized for a substrate thickness of a single-layer optical recording medium. However, in the case of the double-layer optical recording medium, a difference in a thickness occurs by the thickness of the intermediate layer, which may result in degradation of spot performance. Generally speaking, as well known, spherical aberration W₄₀^{rms} is expressed by the following formula:
W₄₀^{rms}≈{1/48\sqrt{5}}{(n²−1)/n³}NA⁴Δt/λ

There, λ denotes an operation wavelength; NA denotes an numerical aperture of an objective lens; n denotes an equivalent refractive index of an optical recording medium; Δt denotes a difference in an optical axis direction from a spot position at which the spherical aberration is minimized. From this formula, it is seen that the spherical aberration W₄₀^{rms} degrades as the NA increases or the wavelength is shortened.

As another problem, it can be said that, cubic coma aberration occurring due to a tilt (inclination) of the optical recording medium increases, when the numerical aperture NA is increased or the wavelength of the light source is shortened. When the cubic coma aberration thus degrades, the spot produced on the information recording surface of the optical recording medium degrades. As a result, it becomes not possible to carry out proper information recording/reproduction operation. Generally speaking, the cubic coma aberration W₃₁ occurring due to a tilt of the optical recording medium is expressed by the following formula:
W₃₁={(n²−1)/(2n³))}×(d×NA³×θ/λ)

There, n denotes a refractive index of a transparent substrate of the optical recording medium; d denotes a thickness of the transparent substrate; NA denotes the numerical aperture of the objective lens; λ denotes the wavelength of the light source; and θ denotes the tilt-amount of the optical recording medium. From this formula, it is seen that, as the wavelength is shortened or NA is increased, the aberration increases.

An object of the present invention is to optimally correct the spherical aberration and the cubic coma aberration occurring due to application of a multi-layer recording medium, shortening of the wavelength or increase in NA, and to provide an optical pickup and an optical information processing apparatus by which satisfactory spot performance can be obtained on any information recording surface of the multi-layer optical recording medium.

In order to achieve the above-mentioned object, the present invention is configured as follows: In the following description, an inter-layer distance between the respective information recording surfaces of the multi-layer optical recording medium is not specifically mentioned, but, instead, a term ‘a difference in a thickness’ is applied. For example, the inter-layer distance is prescribed as being approximately 0.05 mm in a DVD-ROM 2-layer medium which is a conventional optical recording medium. For a blue optical recording medium, the inter-layer distance is assumed as the order reduced from this value by the amount of the wavelength ratio, is assumed. Further, the tilt amount possibly occurring depends on each particular type of the optical recording medium, and should be equivalent to 0.45° for the blue optical recording medium.

According to a first aspect of the present invention, in an optical pickup comprising an objective lens configured to condense and apply laser light, emitted from a light source to an information recording surface of an optical recording medium:

in a case where the optical recording medium comprises a multi-layer optical recording medium having a plurality of information recording surfaces, the following equation is satisfied for each information recording surface x (x=1, 2, . . . ) of the multi-layer optical recording medium:
|CLx/CDx|≧1

where CDx (x=1, 2, . . . ) denotes each least squire error value (unit: λrms) of a cubic coma aberration component occurring per unit angle when the multi-layer optical recording medium is inclined (disk tilt); and

CLx (x=1, 2, . . . ) denotes each least squire error value (unit: λrms) of a cubic coma aberration component occurring per unit angle when the objective lens is inclined (lens tilt), in a case where the laser light is condensed and applied to the predetermined information recording surface x of the multi-layer optical recording medium (see FIG. 3).

According to a second aspect of the present invention, in the above-mentioned configuration of the first aspect of the present invention, the objective lens may be set in such a manner that wavefront aberration for an information recording surface may become smaller than that for another information recording surface located nearer to the laser light applied side.

According to a third aspect of the present invention, in the above-mentioned configuration of any one of the first and second aspects of the present invention, a spherical aberration correcting part may be provided for changing an imaging magnification of the objective lens according to a difference in a thickness up to each information recording surface of the multi-layer optical recording medium.

According to a fourth aspect of the present invention, in the above-mentioned configuration of the third aspect of the present invention, the spherical aberration correcting part may include an auxiliary lens group including a positive lens and a negative lens on a light path between the light source and the objective lens, and lens separation between the auxiliary lens group may be changed in an optical axis direction according to the difference in the thickness up to each information recording surface of the optical recording medium.

According to a fifth aspect of the present invention, in the above-mentioned configuration of the third aspect of the present invention, the spherical aberration correcting part may include a coupling lens on a light path between the light source and the objective lens, and the coupling lens may be moved in an optical axis direction according to the difference in the thickness up to each information recording surface of the optical recording medium.

According to a sixth aspect of the present invention, in the above-mentioned configuration of any one of the first through fifth aspects of the present invention, a driving part configured to incline the objective lens in at least one of a radial direction and a rotating direction of the optical recording medium may be provided.

According to a seventh aspect of the present invention, in the above-mentioned configuration of the sixth aspect of the present invention, an angle detecting part detecting two or more angles selected from among relative angles A, B and C may be provided, where:

the relative angle A denotes a relative angle between the optical recording medium and the objective lens;

the relative angle B denotes a relative angle between the optical recording medium and a predetermined reference surface of the optical pickup; and

the relative angle C denotes a relative angle between the objective lens and the predetermined reference surface of the optical pickup.

According to an eighth aspect of the present invention, in the above-mentioned configuration of the seventh aspect of the present invention, a correcting part configured to provide a predetermined gain or offset to a signal of at least one of the relative angles A, B and C according to the difference in the thickness up to each information recording surface of the multi-layer optical recording medium may be provided.

According to a ninth aspect of the present invention, in the above-mentioned configuration of the seventh aspect of the present invention, a spherical aberration detecting part configured to detect spherical aberration occurring according to the difference in the thickness up to each information recording surface of the multi-layer optical recording medium; and

a correcting part configured to provide a predetermined gain or offset to a signal of at least one of the relative angles A, B and C based on a detection signal output of the spherical aberration detecting part may be provided.

According to a tenth aspect of the present invention, in the above-mentioned configuration of the seventh aspect of the present invention, a thickness detecting part configured to detect the difference in the thickness up to each information recording surface of the multi-layer optical recording medium; and

a correcting part configured to provide a predetermined gain or offset to a signal of at least one of the relative angles A, B and C based on a detection signal output of the thickness detecting part may be provided.

According to an eleventh aspect of the present invention, in the above-mentioned configuration of the sixth aspect of the present invention, a coma aberration detecting part configured to detect cubic coma aberration occurring according to the relative angle between the optical recording medium and the objective lens may be provided.

According to a twelfth aspect of the present invention, in the above-mentioned configuration of any one of the sixth through eleventh aspects of the present invention, the lens driving part may undergo initial inclination adjustment with respect to the information recording surface which is one having a maximum value of CLx.

According to a thirteenth aspect of the present invention, recording information to, reproduction or deletion of information from an optical recording medium is carried out with the use of the optical pickup configured as mentioned above according to any one of the first through twelfth aspects of the present invention.

According to a fourteenth aspect of the present invention, recording information to, reproduction or deletion of information from an optical recording medium, having an information recording surface produced in a range between 0.54 and 0.63 mm from an incident surface of the optical recording medium, is carried out with the use of the optical pickup configured as mentioned above according to any one of the first through twelfth aspects of the present invention.

### BRIEF DESCRIPTION OF THE DRAWINGS

Other objects and further features of the present invention will become more apparent from the following detailed description when read in conjunction with the accompanying drawings:

FIG. 1 is a characteristic diagram showing characteristics before and after spherical aberration correction is carried out;

FIG. 2 is a characteristic diagram showing characteristics before and after coma aberration correction is carried out;

FIG. 3 is a characteristic diagram showing a relationship between a difference in a thickness and coma aberration;

FIG. 4 is characteristic diagrams showing a tilt correction effect responsive to the substrate thickness (difference in the thickness);

FIG. 5 is a characteristic diagram showing residual aberration after correction for a case where the optical recording medium tilt is 0.45°;

FIG. 6 is characteristic diagrams showing a necessary driving amount for the objective lens responsive to the substrate thickness (difference in the thickness);

FIG. 7 roughly shows a general arrangement of an optical pickup according to an embodiment of the present invention;

FIG. 8 shows a detail of a fixed optical system of the optical pickup shown in FIG. 7;

FIG. 9 is a sectional view showing a principle of an example of a multi-layer optical recording medium;

FIG. 10 illustrates spherical aberration and an example of a pattern of a light beam separating device;

FIG. 11 shows a general perspective view of a configuration example of an actuator part;

FIG. 12 shows a general diagram of a configuration example of a tilt detection optical system;

FIG. 13 shows a circuit configuration example of a circuit for calculating a tilt signal;

FIG. 14 shows a front view of a configuration example of a light receiving device for a four-axis actuator;

FIG. 15 illustrates a relationship between an optical recording medium and an interference area;

FIG. 16 illustrates the interference area;

FIG. 17 illustrates a change in the interference area in response to a radial tilt;

FIG. 18 illustrates a change in the interference area in response to a tangential tilt;

FIG. 19 shows a front view of a pattern configuration example of the light receiving device; and

FIG. 20 shows a general perspective view of an embodiment of an optical information processing apparatus.

### DETAILED DESCRIPTION OF THE PREFERRED EMBODIMENTS

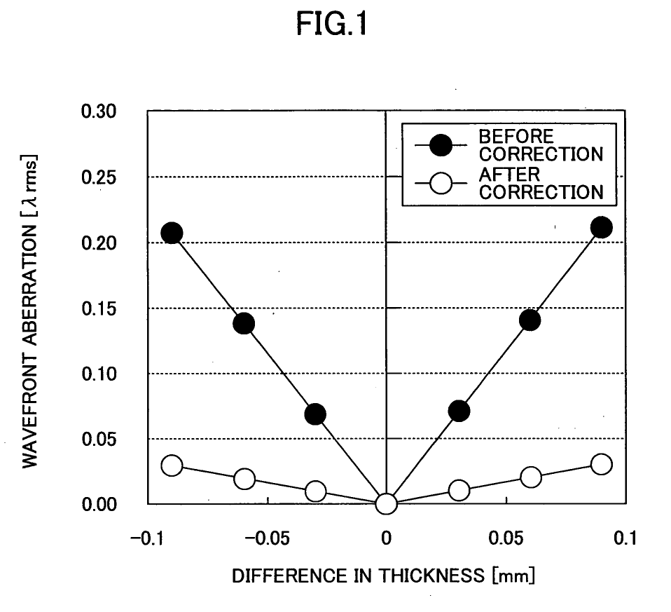

According to one embodiment of the present invention, a spherical aberration correcting part is provided (according to the above-mentioned third through fifth aspects of the present invention) for changing imaging magnification of the objective lens. To change the imaging magnification means to change a divergence state or a convergence state of an incident beam on the objective lens. Thereby, the spherical aberration changes. Accordingly, it is possible to cancel out therewith the spherical aberration occurring due to the difference in the thickness between the respective information recording surfaces of the multi-layer optical recording medium. For example, in a blue optical system having an objective lens optimally designed for a substrate thickness of 0.6 mm; a numerical aperture NA of 0.65; and an operation wavelength of 405 nm, wavefront aberration occurring due to the difference in the thickness is as shown in FIG. 1, ‘●’, while, as a result of the imaging magnification being changed responsive to the difference in the thickness (abscissa axis), it is possible to correct the wavefront aberration as shown in FIG. 1, ‘◯’.

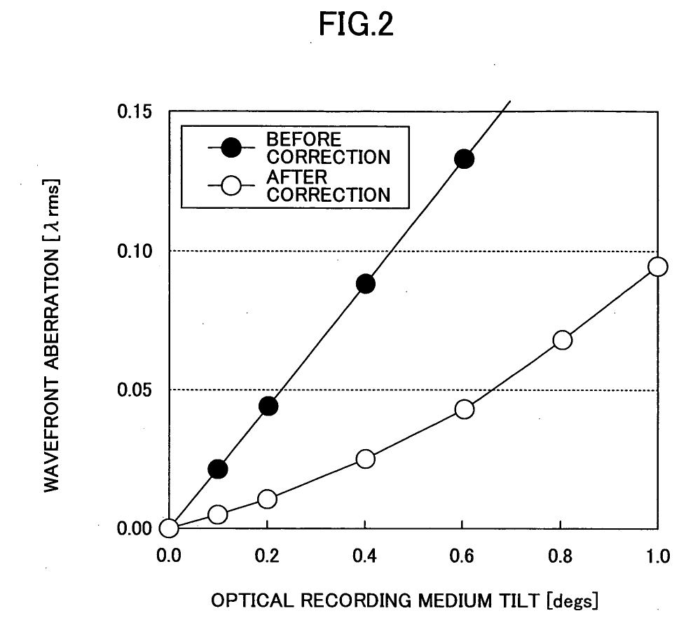

According to another embodiment of the present invention, a lens driving part is provided (according to the above-mentioned sixth aspect of the present invention) for inclining the objective lens in at least one of a radial direction and a rotating direction of the optical recording medium. Cubic coma aberration occurs when the objective lens is inclined. Accordingly, it is possible to cancel out therewith the cubic coma aberration occurring due to a tilt of the optical recording medium. For example, in a blue optical system having an objective lens optimally designed for a substrate thickness of 0.6 mm; a numerical aperture NA of 0.65; and an operation wavelength of 405 nm, wavefront aberration occurring due to a tilt of the optical recording medium is as shown in FIG. 2, ‘●’, while, as a result of the objective lens being tilted responsive to the tilt of the optical recording medium (abscissa axis), it is possible to correct the wavefront aberration as shown in FIG. 2, ‘◯’.

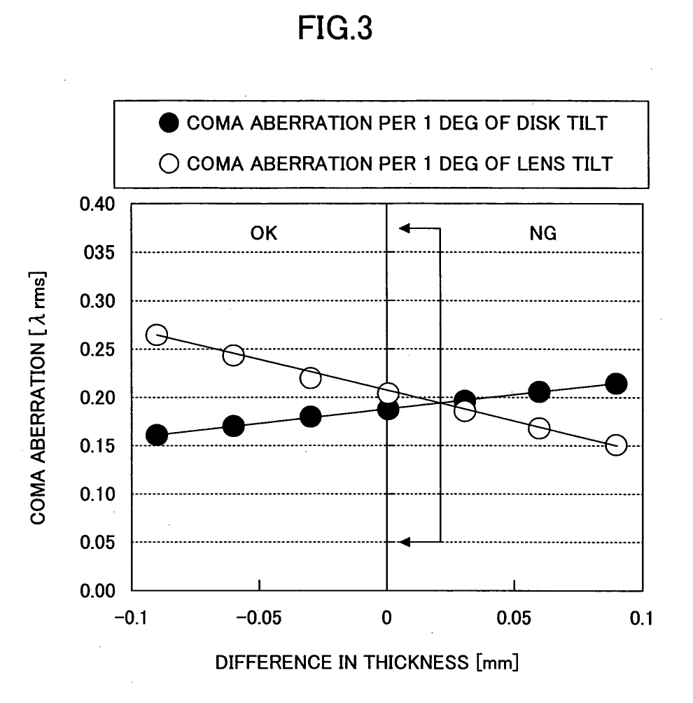

FIG. 3 shows cubic coma aberration occurring per 1° of a lens tilt of the objective lens and cubic coma aberration occurring per 1° of a tilt of the optical recording medium in a blue optical system having an objective lens optimally designed for a substrate thickness of 0.6 mm; a numerical aperture NA of 0.65; and an operation wavelength of 405 nm. In the optical pickup according to the present invention which is a base configuration of the above-mentioned third through sixth aspects of the present invention, setting is made such that, in a case where the optical recording medium is a multi-layer optical recording medium having a plurality of information recording surfaces, the following equation is satisfied for each information recording surface x (x=1, 2, . . . ) of the multi-layer optical recording medium:
|CLx/CDx|≧1

where CDx (x=1, 2, . . . ) denotes each least squire error value (unit: λrms) of a cubic coma aberration component occurring per unit angle when the multi-layer optical recording medium is inclined; and CLx (x=1, 2, . . . ) denotes each least squire error value (unit: λrms) of a cubic coma aberration component occurring per unit angle when the objective lens is inclined in a case where the laser light is condensed and applied to a predetermined information recording surface x of the multi-layer optical recording medium.

As a result of these requirements being met, it becomes possible to sufficiently correct the cubic coma aberration occurring due to a tilt of the optical recording medium, by means of a tilt of the objective lens. As a result, it becomes possible to obtain a satisfactory spot on each information recording surface of the multi-layer optical recording medium.

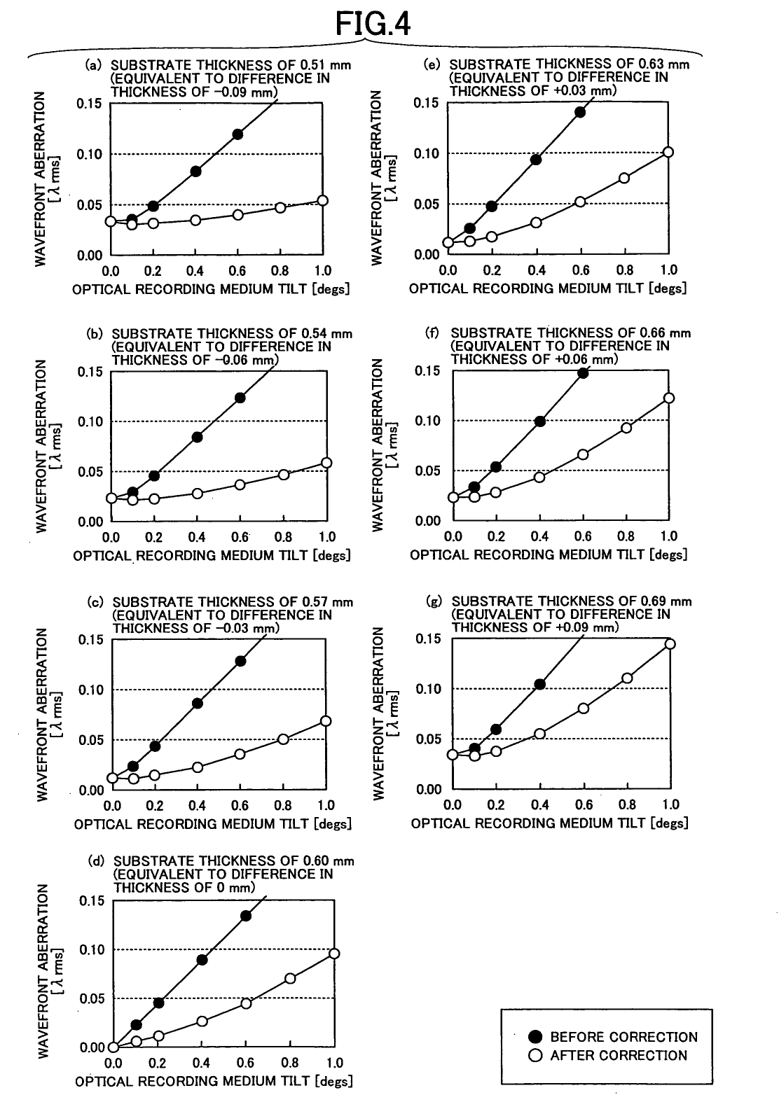

FIG. 4 shows aberration characteristic diagrams obtained when the cubic coma aberration occurring due to a tilt of the optical recording medium is corrected by means of a lens tilt (lens inclination) with the use of an objective lens optimized for a substrate thickness of 0.6 mm for each of the respective optical recording media having substrate thickness of 0.51 mm, 0.54 mm, 0.60 mm, 0.63 mm, 0.66 mm, 0.69 mm (corresponding to differences in the thickness; −0.09 mm, −0.06 mm, −0.03 mm, 0, +0.03 mm, +0.06 mm, +0.09 mm, respectively). From the diagrams, it is seen that the correction effect by means of the lens tilt is larger when the substrate thickness is smaller, while, as shown in FIG. 4, (e) through (g), it is not possible to sufficiently control the cubic coma aberration occurring due to a tilt of the optical recording medium even when the objective lens is tilted for a range in which the above-mentioned conditional formula (|CLx/CDx|≧1) is not met.

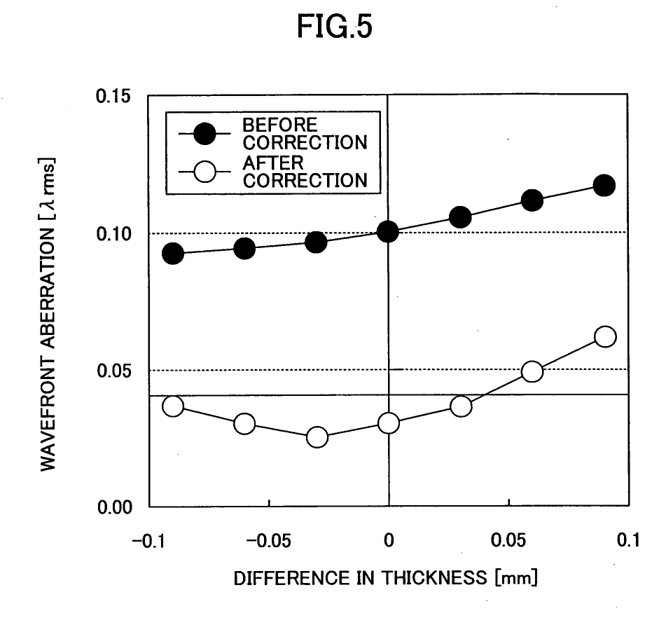

FIG. 5 shows a result of extracting characteristics for a case where a tilt amount of the optical recording medium is 0.45°, in consideration of the tilt amount of 0.45° occurring as mentioned above for the case of the blue optical recording medium. Normally, upon reading a signal from the optical recording medium, it is known experientially that a wavefront aberration value should be less than a marshal criterion (0.07 λrms). Since the wavefront aberration should include aberration of the objective lens or such, it is said that an allowable limit should be less than 0.04 λrms which is on the order of a half of the above-mentioned 0.07 λrms. In the range in which the above-mentioned conditional formula is met in FIG. 5, it is possible to obtain a signal of less than 0.04 λrms.

The wavefront aberration starts degrading again when the difference in the thickness becomes less than −0.05 mm as shown in FIG. 5. This is because of influence of residual spherical aberration occurring due to the difference in the thickness.

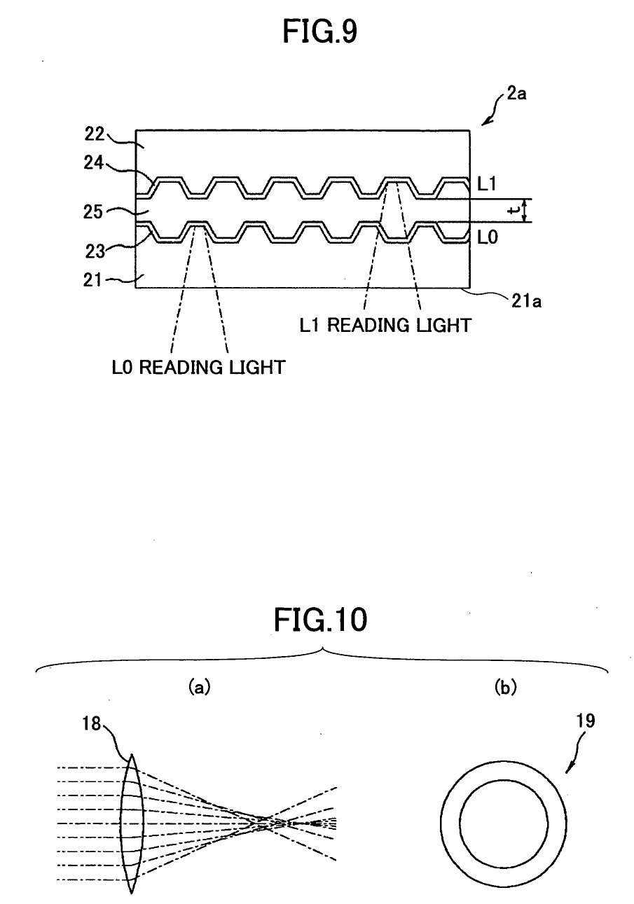

Accordingly, in order to control the wavefront aberration to less than 0.04 λrms in FIG. 5, setting is made in such a manner that the information recording surface of the optical recording medium may exist in a range between 0.54 and 0.63 mm with respect to the reference substrate thickness of 0.6 mm (single-layer optical recording medium). That is, the layer L0 and the layer L1 should exist in the range between 0.54 and 0.63 mm from an incident surface 21a of the optical recording medium 2a in FIG. 9 for exmaple. In other words, it is seen therefrom that the intermediate layer should be provided in this range. For example, in a case of a double-layer optical recording medium, a combination is provided between the optical recording medium having the layer L0 at a position corresponding to a substrate thickness of 0.57 mm, and the layer L1 at a position corresponding to a substrate thickness of 0.60 mm, with the optical pickup.

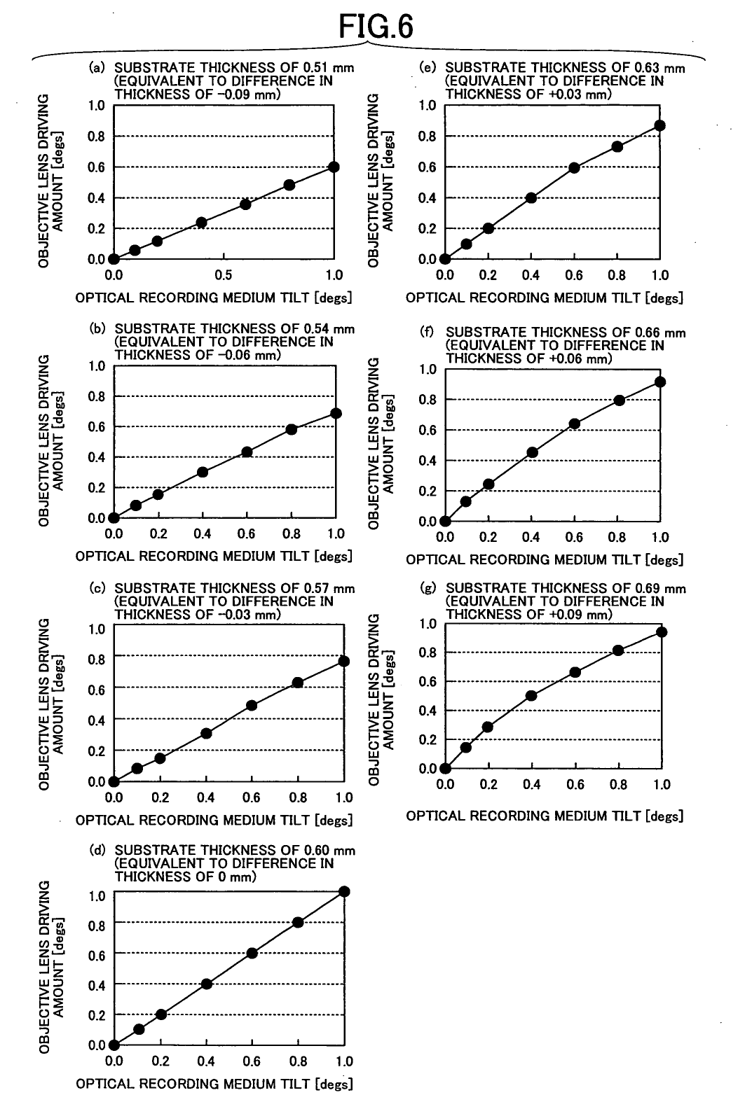

FIG. 6 shows, corresponding to FIG. 4, a necessary lens driving amount for the objective lens for correcting the optical recording medium tilt. As shown in FIG. 6, (e) through (g), the lens tilt driving amount for the optical recording medium tilt is non-linear for the range in which the above-mentioned conditional formula is not met. In such a case, required control is complicated, and thus, this range is not preferable.

For example, as can be seen from FIG. 6, when the layer L0 is located at the position of 0.57 mm and the layer L1 is located at the position of 0.60 mm, the cubic coma aberration on each information recording surface can be corrected as a result of inclining the objective lens by 0.8° in the same direction when the optical recording medium is inclined by 1° for the L0 layer (see FIG. 6, (c)), while, inclining the objective lens by 1.0° in the same direction when the optical recording medium is inclined by 1° for the L1 layer (see FIG. 6, (d)).

According to another embodiment of the present invention, a spherical aberration detecting part is provided (according to the above-mentioned eighth and ninth aspects of the present invention) to detect the difference in the thickness up to each information recording surface or the spherical aberration occurring due to the difference in the thickness. Thereby, it is possible to correct the thickness difference signal by means of a tilt detection signal separately provided (according to the above-mentioned seventh aspect of the present invention), and thus, it is possible to achieve further satisfactory cubic coma aberration correction.

Thus, according to the present invention, it is possible to obtain satisfactory spot performance for a position of each information recording surface of the multi-layer optical recording medium in the optical pickup or in the optical information processing apparatus for which a recording capacity is increased by means of applying a multi-layer optical recording medium and shortening the operation wavelength.

A best mode of carrying out the present invention is described below with reference to figures.

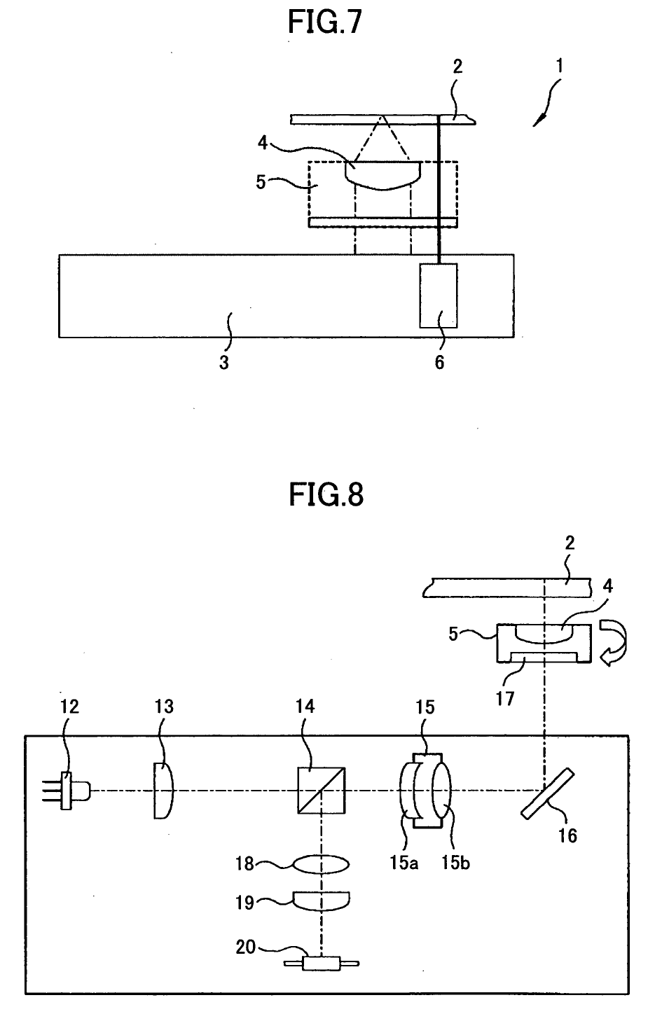

First, with reference to FIG. 7, a general configuration example of an optical pickup 1 according to an embodiment of the present invention is described. The optical pickup 1 carrying out recording information to, reproducing information from or deleting information from an optical recording medium 2, condenses light emitted from a fixed optical system 3 onto the optical recording medium 2 by means of an objective lens 4, obtains a signal from reflected light thereof by means of a detection system (described later) disposed in the fixed optical system 3, and, based on the signal, carries out operation of recording information, reproducing information or deleting information. Further, separate from the fixed optical system 3, an actuator part 5 acting as a lens driving device to incline the objective lens 4 and a tilt detecting part 6 detecting a tilt of the optical recording medium 2 are provided. According to a tilt amount detected from the tilt detecting part 6, the actuator part 5 is controlled so as to tilt the objective lens 4 so that the optical axis of the objective lens 4 may have a predetermined angle from the surface of the optical recording medium 2.

With reference to FIG. 8, a configuration example of the fixed optical system 3 carrying out signal reading is described now. The optical pickup 1 according to the embodiment of the present invention includes a semiconductor laser 12 acting as a light source of a blue wavelength band; a coupling lens 13; a polarization beam splitter 14; a spherical aberration correcting part 15; deflection prism 16; a ¼ wavelength plate 17; the objective lens 4; a detection lens 18; a beam separating part 19; and a light receiving device 20.

Divergent light of linear polarization emitted from the semiconductor laser 12 of a wavelength of 405 nm is transformed into approximately parallel light by means of the coupling lens 13, passes through the polarization beam splitter 14 and the spherical aberration correcting part 15, is deflected in its light path by means of the deflection prism 16, is transformed into circular polarized light by means of the ¼ wavelength plate 17, is applied to the objective lens 4, and is condensed on the optical recording medium 2 in a form of a slight spot by the objective lens 4. Light then reflected by the optical recording medium 2 is circular polarized light having a rotation reverse to that of the going light path, is transformed again into approximately parallel light, passes through the ¼ wavelength plate 17 so as to be transformed to be linear polarized light perpendicular to that of the going light path, is reflected by the polarization beam splitter 14, is transformed into convergent light by means of the detection lens 18, is deflected and separated by means of the beam separating part 19 into a plurality of light paths, and reaches the light receiving device 20. From the light receiving device 20, an information signal, a servo signal or such is detected.

As described above, in order to record an HDTV program for more than two hours, a recording capacity of more than 22 GB is required. In order to achieve the recording capacity of more than 22 GB, it is necessary to change, from those of a conventionally known single-layer DVD optical recording medium, an operation wavelength λ, a numerical aperture NA or the number L of information recording layers. Requirements to be satisfied for this purpose are expressed by the following formula:
L×{(0.66/λ)/(0.65/NA)}²≧(22/4.7)

L=2 has been already achieved in a DVD optical recording medium, specially, a so-called DVD-ROM optical recording medium used specially for information reproduction. If NA is increased, it is necessary to increase the manufacturing tolerance of the objective lens, which may result in cost rise. In order to avoid it, the numerical aperture NA is set the same as that of DVD, i.e., 0.65; and, as the operation wavelength, 405 nm is applied which is of a blue semiconductor laser which is shorter than that of a red wavelength band semiconductor laser used in DVD. In this condition, the recording capacity more than 22 GB is achievable in the optical recording medium by applying L=2, which results in approximately 22 GB in fact.

That is, in the optical pickup 1 according to the embodiment of the present invention, while it is possible to apply a single-layer DVD optical recording medium as the optical recording medium 2, it is also possible to apply a multi-layer optical recording medium. FIG. 9 shows a double-layer optical recording medium 2a which is an example of the multi-layer optical recording medium. By increasing the number of information recording layers into n layers, it is possible to increase the recording capacity by approximately n times. The double-layer optical recording medium 2a has a structure in which signal surfaces (information recording surfaces) of two substrates 21 and 22 produced by way of injection molding are caused to adhere to one another in such a manner that both signal surfaces may face one another. The first layer from the reading side (the side toward the light source) is called layer 0 (layer0; or referred to as L0, hereinafter) while the second layer is called layer 1 (layer1; or referred to as L1, hereinafter). A reflective film 23 of the layer L0 is a semi-transparent film so that, being transmitted thereby, a signal may be read out from the layer L1, and is made of gold or dielectric. As a reflective film 24 of the layer L1, an aluminum reflective film the same as that of the single-layer optical recording medium is applied. An intermediate layer 25 is provided between the layers L0 and L1 so as to separate the signal surfaces with a predetermined thickness t. Since the intermediate layer 25 acts as a light path for the reading light, ultraviolet curing resin material having high transmittance for the wavelength of the reading light and having a refractive index close to that of the substrates is applied. By moving a focus of the reading beam (focus jump), it is possible to read information only from any one of the layers L0 and L1.

In the optical pickup according to the embodiment of the present invention, setting is made such that the following equation is satisfied for each information recording surface x (x=1 or 2) of the multi-layer optical recording medium 2a:
|CLx/CDx|≧1

where CDx (x=1 or 2) denotes each least squire error value (unit: λrms) of a cubic coma aberration component occurring per unit angle when the multi-layer optical recording medium 2a is inclined; and CLx (x=1 or 2) denotes each least squire error value (unit: λrms) of a cubic coma aberration component occurring per unit angle when the objective lens 4 is inclined in a case where the laser light is condensed and applied to the predetermined information recording surface x of the multi-layer optical recording medium.

That is, the following formulas should be satisfied:
|CL1/CD1|≧1
|CL2/CD2|≧1

Specifically, for example, in the case of applying the double-layer optical recording medium 2a, having the L0 layer at a position corresponding to a substrate thickness of 0.57 mm; and having the L1 layer at a position corresponding to a substrate thickness of 0.60 mm, is combined with the optical pickup 1. This also means that the objective lens 4 is set in such a manner that wavefront aberration may become smaller for the information recording surface L1 which is located farther from the laser light incident side than that for the information recording surface L0 which is located nearer to the laser light incident side (see FIGS. 1, 3 and 4, (c) and (d)).

Further, in the present embodiment, the spherical aberration correcting part 15 changing the imaging magnification of the objective lens 4 is provided. By changing the imaging magnification therewith, the incident beam to the objective lens 4 is transformed into one in a divergent state or one in a convergent state, and thereby, the spherical aberration is positively changed. As a result, the spherical aberration occurring due to a thickness difference between the respective information recording surfaces of the multi-layer optical recording medium 2a is canceled out.

The spherical aberration correcting part 15 provided for changing the imaging magnification is configured by, in an example shown in FIG. 8 for example, an auxiliary lens group including two lenses 15a and 15b, and a separation adjusting part (not shown) configured to adjust the separation between these lenses 15a and 15b. One of the two lenses 15a and 15b is a positive lens and the other is a negative lens. In the example of FIG. 8, the negative lens is located on the side of the light source 12. However, it is also possible to dispose the positive lens on the side of the light source 12 instead. By changing the separation between the positive and negative lenses of the spherical aberration correcting part 15, a divergent state of a light beam transmitted by the spherical aberration correcting part 15 led to the objective lens 4 changes, and thus, spherical aberration occurs in the beam having passed through the objective lens 4. The thus-generated spherical aberration should be used to cancel out the spherical aberration occurring due to the thickness t of the intermediate layer 25 of the multi-layer optical recording medium 2a.

As the spherical aberration correcting part, it is not necessary to limit to that 15 shown in FIG. 8. Other than that, a configuration may be applied in which a divergent state of a light beam having passed through the coupling lens 13 led to the objective lens 4 is changed as a result of the coupling lens 13 being moved in the optical axis direction, so that spherical aberration may be generated in a light beam having passed through the objective lens 4.

For example, in the blue optical system as that according to the embodiment of the present invention having the objective lens 4 designed optimally for the substrate thickness of 0.6 mm; the numerical aperture NA of 0.65; and the operation wavelength λ of 405 nm, it is possible to carry out correction of wavefront aberration occurring due to the difference in the thickness into a curve of ‘◯’ shown FIG. 1 from a curve of ‘●’, as a result of the imaging magnification of the objective lens being thus changed by means of the spherical aberration correcting part 15 according to the difference in the thickness (for any of the layers L0 and L1).

Further, in the optical pickup 1 of the embodiment shown in FIG. 8, the spherical aberration detecting part is configured by the beam separating part 19 and the light receiving part 20. As described above, spherical aberration occurs on each information recording surface due to the thickness of the intermediate layer 25, and thereby, the light spot produced on the information recording surface degrades. The thus-occurring spherical aberration results in distortion of a wavefront of the returning light beam, and as a result, aberration also occurs in the light beam thus applied to the light receiving device 20 via the detection lens 18. FIG. 10, (a) shows this state. When spherical aberration occurs in the returning beam returning to the detection lens 18, ‘a delay of wavefront’ occurs concentrically about the optical axis with respect to the reference wavefront of the returning light beam. As a result, a position at which the thus-delayed wavefront is focused corresponds to a defocused position with respect to a focused position at which the reference wavefront is focused. Therefore, by detecting a focus state by taking a difference between the delayed wavefront and the advanced wavefront, it is possible to obtain a state of generation of the spherical aberration. For this purpose, for example, a hologram should be disposed as the beam separating part 19 as shown in FIG. 10, (b), and the light receiving device 20 is provided having a light receiving area separated so that the thus-separated respective light beams may be detected thereby respectively.

Alternatively, instead of detecting the spherical aberration, the thickness itself between the substrate surface and the information recording surface of the optical recording medium 2 may be detected as the difference in the thickness (thickness detecting part). Generally speaking, a focus signal provided for controlling the position of the objective lens 4 in the optical axis direction has zero crossing on the substrate surface or the information recording surface of the optical recording medium 2. Therefore, by measuring the distance thereof, the thickness can be obtained.

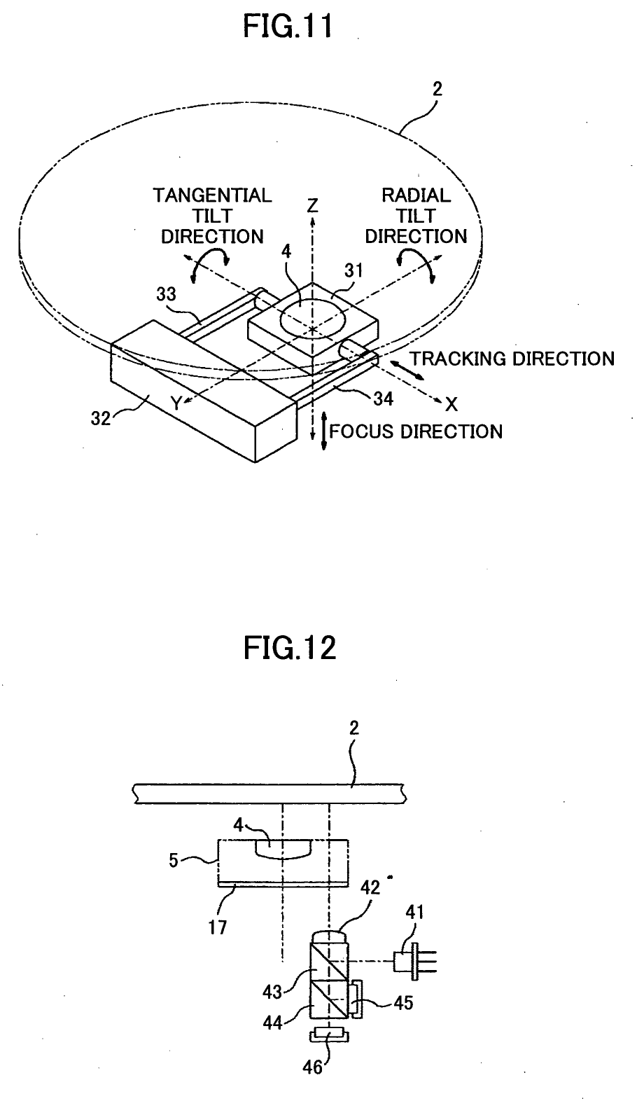

With reference to a general perspective view of FIG. 11, a configuration example of the above-mentioned actuator part 5 is described now. The actuator part 5 includes, for an objective lens supporting member 31 configured to support the objective lens 4, a base part 32 configured to support the objective lens supporting member 31; and elastic supporting members 33 and 34 inserted between the base part 32 and the objective lens supporting member 31. The elastic supporting members 33 and 34 are configured to elastically support the objective lens supporting member 31 with respect to the base part 32 in such a manner that the objective lens supporting member 31 may move in any one of four directions, i.e., a focus direction, a tracking direction, a radial tilt direction and a tangential tilt direction. The focus direction is a z-axis direction (the optical axis direction of the objective lens 4) of FIG. 11; the tracking direction is an x-axis direction (a radial direction of the optical recording medium 2) of FIG. 11; the radial tilt direction is a tilt direction about the y axis (a tilt direction with respective to the radial direction of the optical recording medium 2) of FIG. 11; and the tangential tilt direction is a tilt direction about the x axis (a tilt direction with respect to the rotating direction of the optical recording medium 2). Further, a driving part (not shown) is provided in the configuration shown in FIG. 11, and, for example, this part includes a so-called voice coil motor including a permanent magnet provided in the objective lens supporting member 31 and a driving coil fixed relatively to the base part 32. This driving part drives the objective lens supporting member 31 in any one of the above-mentioned four directions according to an input electric current supplied to the driving coil. A configuration is applied such that focus servo control and tracking servo control are carried out for causing the predetermined laser light to follow a recording track of the information recording surface of the optical recording medium 2 with control of the input electric current of the driving coil, and also, tilt servo control is carried out for controlling an incident direction of the laser light (that is, the optical axis of the objective lens) in such a direction as to suppress cubic coma aberration of the information recording surface of the optical recording medium 2.

The actuator part 5 (lens driving device) thus configured to incline the objective lens 4 is provided, and, cubic coma aberration is generated as the objective lens 4 being thus positively inclined. Thereby, it is possible to cancel out the cubic coma aberration occurring due to an inclination of the optical recording medium 2. For example, in the blue optical system having the objective lens 4 optimally designed for the substrate thickness of 0.6 mm; the numerical aperture NA of 0.65; and the operation wavelength λ of 405 nm, wavefront aberration occurring due to the difference in the thickness is as shown in a curve of ‘●’ of FIG. 2. Then, by inclining (tilting) the objective lens 4 according to an actual tilt (abscissa axis) of the optical recording medium 2, it is possible to correct the wavefront aberration as shown in a curve of ‘◯’ of FIG. 2. In particular, since the present embodiment satisfies the above-described requirements (|CLx/CDx|≧1) for each information recording surface of the multi-layer optical recording medium 2a, it is possible to correct the cubic coma aberration responsive to an actual tilt of the optical recording medium 2, by the lens tilt, as shown in FIG. 4, (a) through (d) and FIG. 5.

FIG. 12 shows an optical system configuration example of the above-mentioned tilt detecting part 6 configured to detect a tilt of the optical recording medium 2. This tilt detecting part 6 mainly includes a semiconductor laser 41, a collimator lens 42, a half mirror 43, the ¼ wavelength plate 17, a polarization beam splitter 44, a first light receiving device 45 and a second light receiving device 46. A divergent light of linear polarization emitted from the semiconductor laser 41 is deflected in its light path by 90° by the half mirror 43, and is transformed into approximately parallel light by the collimator lens 42. On a surface of the ¼ wavelength plate 17 on the side of the light source, predetermined coating is made, whereby a part of the light applied from the half mirror 43 thereto is reflected and the other component is transmitted. The light transmitted by the ¼ wavelength plate 17 is transformed into light of circular polarization by passing through the ¼ wavelength plate 17, and is reflected by the optical recording medium 2. The reflected light from the optical recording medium 2 is of circular polarization in reverse rotation from that of the going light (incident light), and, becomes light of linear polarization perpendicular to that of the going light as a result of passing through the ¼ wavelength plate 17 again. That is, the light reflected by the surface of the ¼ wavelength plate 17 first and the light having passed through the ¼ wavelength plate 17 and then reflected by the optical recording medium 2 are applied to the collimator lens 42 as reflected light in a state in which one light is perpendicular to the other in their polarization directions. Each reflected light then passes through approximately the same light path, passes through the half mirror 43, and is applied to the polarization beam splitter 44. Light paths of the light reflected by the surface of the ¼ wavelength plate 17 and the light reflected by the optical recording medium 2 are then separated by the polarization beam splitter 44. The reflected light from the optical recording medium 2 is reflected by the polarization beam splitter 44 and is applied to the first light receiving device 45, while the reflected light directly from the ¼ wavelength plate 17 is transmitted by the polarization beam splitter 44 and reaches the second light receiving device 46.

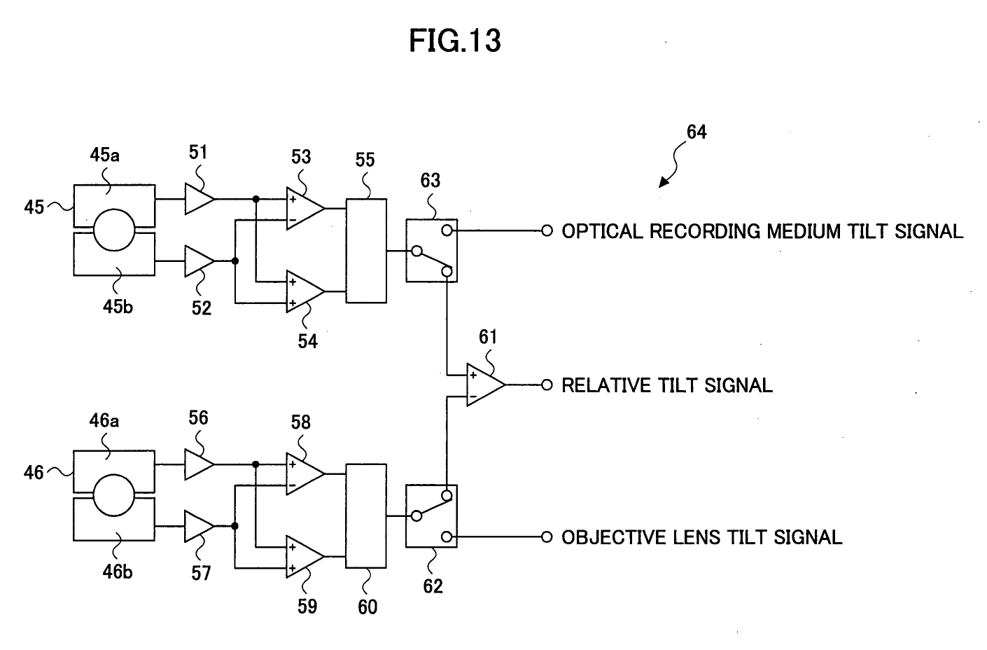

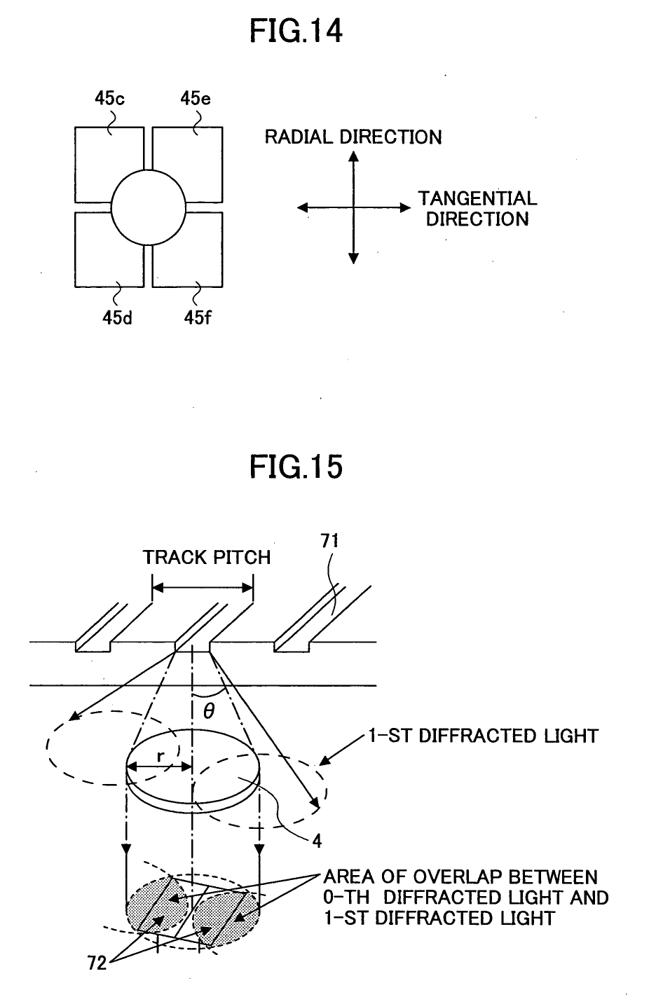

With reference to FIG. 13, a detailed configuration example of an operation part for output values from the first and second light receiving devices 45 and 46 is described now. Here, for the purpose of simplification, description is made only for one direction, for example, a radial direction. Specifically, actually, as the first light receiving device 45 (the same as the second light receiving part 45), a four separate light receiving device including four separate light receiving parts 45c through 45f is applied. However, here, in order to proceed with the description only for one direction, it is assumed that a two separate light receiving device including only two light receiving parts 45a and 45b is applied as the first light receiving device 45. Similarly, it is assumed that a two separate light receiving device including only two light receiving parts 46a and 46b is applied as the second light receiving device 46.

First, for the purpose of detecting a tilt amount of the optical recording medium 2, the first light receiving device 45 configured to detect the reflected light from the optical recording medium 2 includes the pair of the light receiving parts 45a and 45b as mentioned above. The pair of the light receiving parts 45a and 45b are arranged along a radial direction of the optical recording medium 2. Thereby, when the optical recording medium 2 tilts, a level of the detection signal from one of the pair of the light receiving parts 45a and 45b becomes larger than the other according to the direction of the inclination. The pair of the light receiving parts 45a and 45b are connected to pre-amplifiers 51 and 52, respectively. These pre-amplifiers 51 and 52 are connected to a differential circuit 53 which outputs a difference between the output signals of the pre-amplifiers 51 and 52 as a differential output signal. By operating the differential output signal from the differential circuit 53, a tilt amount of the optical recording medium 2 can be obtained. When the reflectance of the optical recording medium 2 fluctuates or the light intensity of the light beam emitted from the light source 41 fluctuates temporally, the characteristics of the detection signals from the pre-amplifiers fluctuate accordingly. These fluctuations are corrected by a circuit connected subsequently. That is, the signals from the pre-amplifiers 51 and 52 are added together by an adding circuit 54, and the addition output is input to a dividing circuit 55. The dividing circuit 55 normalizes the differential output from the differential circuit 53 with the use of the addition output as a reference level. Thus, the fluctuation component included in the differential output is removed, and as a result, from the dividing circuit 55, the tilt signal of the optical recording medium 2 (the relative angle B mentioned below) is generated.

On the other hand, for the purpose of detecting a tilt amount of the actuator part 5 on which the objective lens 4 and the ¼ wavelength plat 17 are mounted, the second light receiving device 46, configured to detect the directly reflected light from the ¼ wavelength plate 17 installed on the actuator part 5, includes the pair of the light receiving parts 46a and 46b as mentioned above. When the objective lens 4 is inclined and thus the ¼ wavelength plate 17 is inclined in the same way accordingly, a level of the detection signal from one of the pair of the light receiving parts 46a and 46b, receiving the reflected light from the ¼ wavelength plate 17 as mentioned above, becomes larger than the other according to the direction of the inclination. The pair of the light receiving parts 46a and 46b are connected to pre-amplifiers 56 and 57, respectively. These pre-amplifiers 56 and 57 are connected to a differential circuit 58 which outputs a difference between the output signals of the pre-amplifiers 56 and 57 as a differential output signal. By operating the differential output signal from the differential circuit 58, a tilt amount of the actuator part 5, that is, a tilt amount of the objective lens 4 can be obtained. When the light intensity of the light beam emitted from the light source 41 fluctuates temporally, the characteristics of the detecting signals form the pre-amplifiers 56 and 57 fluctuate accordingly. These fluctuations are corrected by a circuit connected subsequently. That is, the signals from the pre-amplifiers 56 and 57 are added together by an adding circuit 59, and the addition output is input to a dividing circuit 60. The dividing circuit 60 normalizes the differential output from the differential circuit 58 with the use of the addition output as a reference level Thus, the fluctuation component included in the differential output is thus removed, and as a result, from the dividing circuit 60, the tilt signal of the objective lens 4 (the relative angle C mentioned below) is generated.

The dividing circuits 55 and 60 outputting the tilt signals corresponding to the respective tilt amounts of the optical recording medium 2 and the objective lens 4 are further connected to a differential circuit 61, which generates a difference between these tilt signals. This difference output from the differential circuit 61 corresponds to a relative tilt amount of the objective lens 4 with respective to the optical recording medium 2 (the relative angle A mentioned below). Switches 62 and 63 are set before the differential circuit 61, and thereby, it is possible to select any one of the objective lens tilt signal (the relative angle C), the optical recording medium tilt signal (the relative angle B) and the relative tilt signal (the relative angle A). That is, an angle detecting part 64 (to output any one of the relative angles A, B and C) is configured by the circuit shown in FIG. 13.

For example, for the case of the double-layer optical recording medium 2a, the optimum lens tilt amount with respect to the optical recording medium tilt differs according to each particular one of the layers L0 and L1. According to the present embodiment of the present invention, the following three types of relative angles are thus detected:

1) the relative angle A between the optical recording medium 2 and the objective lens 4 (i.e., the output of the differential circuit 61);

2) the relative angle B between the optical recording medium 2 and the predetermined reference surface of the optical pickup 1 (i.e., the output of the dividing circuit 55); and

3) the relative angle C between the objective lens 4 and the predetermined reference surface of the optical pickup 1 (i.e., the output of the dividing circuit 60).

Accordingly, control should be carried out based on a map which is—previously recorded. For example, in FIG. 6, (a), when the signal indicating that the relative angle between the optical recording medium 2 and the predetermined reference plane of the optical pickup is 0.6° detected, feedback control should be carried out such that the relative angle between the objective lens 4 and the predetermined reference plane of the optical pickup 1 may become 0.4°, according to the curve shown in FIG. 6, (a).

As shown in FIG. 6, the objective lens tilt amount required to correct the tilt of the optical recording medium 2 differs according to each particular difference in the thickness. In the present embodiment of the present invention, a predetermined gain (not shown) may be switched according to each particular position of the information recording surface when the above-mentioned tilt control operation is carried out. That is, since the correction lens tilt amount differs according to the difference in the thickness as mentioned above, a gain may be added to any one of the above-mentioned relative angles of the items 2) and 3) such that an equivalent level of the signal may be always output.

For the purpose of correcting cubic coma aberration occurring due to inclination error of the incident light beam on the objective lens 4 occurring upon assembly adjustment of the optical pickup 1 or due to manufacture error of the objective lens 4, inclination of the lens tilt actuator is adjusted when it is assembled. This inclination adjustment is preferably carried out for the information recording surface especially for which the cubic coma aberration degradation due to a lens tilt is worst. In this case, no assembly adjustment is carried out especially for the other information recording surface(s). However, according to the embodiment of the present invention, it is possible to correct the cubic coma aberration for the assembly manufacture error amount also by means of the lens tilt operation simultaneously, as a result of previously obtaining the objective lens optimum position for correcting the cubic coma aberration occurring due to the inclination error of the incident light beam to he objective lens 4 or the manufacture error of the objective lens 4 in a stage of the optical pickup assembly process, and then, offsetting the relationships of FIG. 6 to the thus-obtained optimum position. Further, it is also possible not to carry out the former inclination adjustment (the adjustment especially for the information recording surface having the worst cubic coma aberration), and the former inclination adjustment may also be carried out by means of the lens tilt operation simultaneously.

In the optical pickup 1 according to the embodiment of the present invention, the tilt angle of the objective lens 4 or the optical recording medium 2 is applied as the driving signal of the actuator part 5. However, alternatively, it is also possible to directly correct the cubic coma aberration occurring due to a relative tilt between the objective lens 4 and the optical recording medium 2. A method of detecting the cubic coma aberration for this purpose is described next.

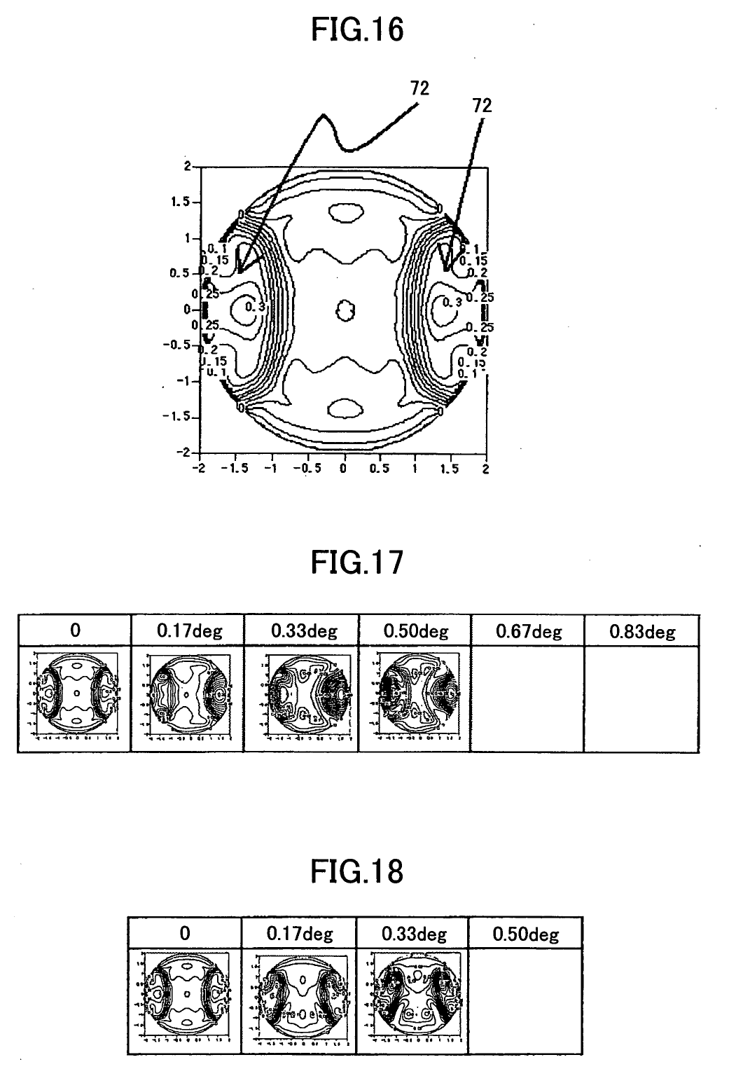

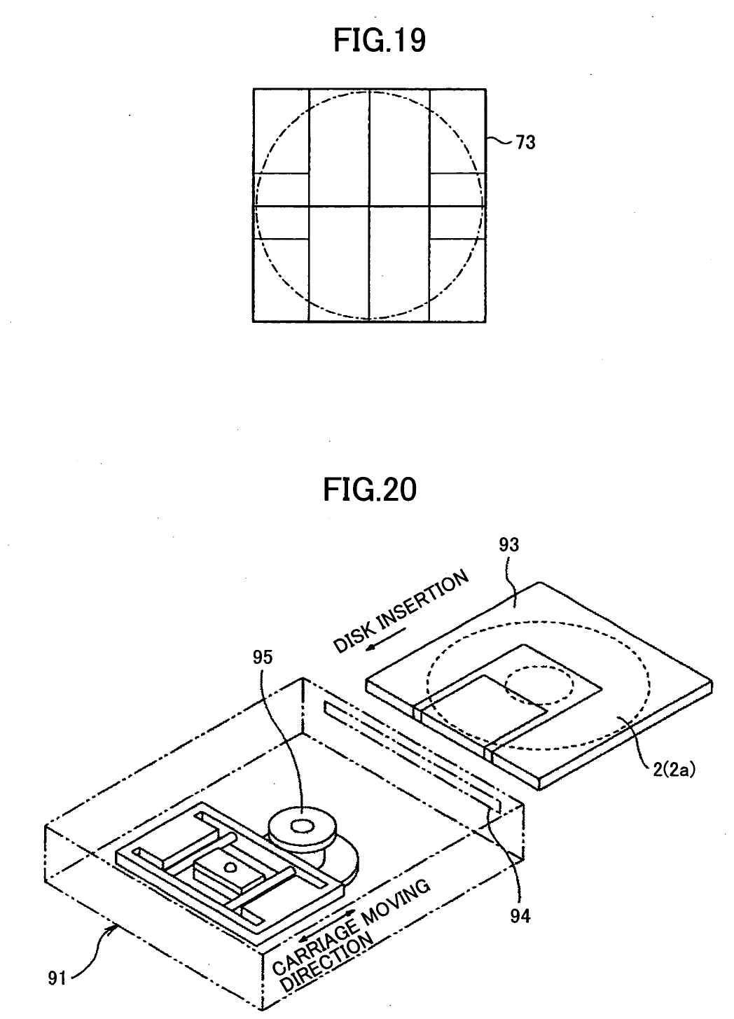

As shown in FIG. 15, a guide groove 71 is formed on the optical recording medium 2. Reflected light from the groove 71 includes 0-th light which is direct reflected light and ±1-st light which is light diffracted, each of which interferes mutually. FIG. 16 shows the 0-th light (straight forward traveling light) and the ±1-st light received by the light receiving surface of the light receiving device 20, viewed from the top of the light receiving surface. The 0-th light (straight forward traveling light) and the 1-st light overlap as shown, and the overlapping areas are called interference areas 72.

With reference to FIGS. 17 and 18, how these interference areas 72 change according to a tilt of the optical recording medium 2 is described next. FIG. 17 shows a change of the interference areas 72 when the optical recording medium 2 inclines in a radial direction. Along with the tilt, a deviation occurs between the left and right parts in FIG. 17. This is because cubic coma aberration occurs in a spot projected on the optical recording medium 2 due to th tilt of the optical recording medium 2. This deviation occurs in opposite directions between one interference area 72 and the other interference area 72. In FIG. 17, as the tilt increases, the right area increases while the left area decreases in the intensity, gradually, as can be seen. Similarly, FIG. 18 shows a change in the interference areas 72 when the optical recording medium 2 inclines in a rotating direction (tangential direction).

Accordingly, the cubic coma aberration can be detected by detecting such a change in the light amount (intensity) distribution. For example, a light receiving device 73 having a plurality of division light receiving parts such that a change of a geographical pattern of the light amount in the interference areas 72 may be detected, may be applied for this purpose.

FIG. 20 shows a general perspective view of an optical information processing apparatus according to an embodiment of the present invention. The optical information processing apparatus 91 according to the embodiment of the present invention is configured to carry out recording of information to, reproduction of information from or deletion of information from an optical recording medium 2 such as the multi-layer optical recording medium 2a for example, with compatibility, with the use of an optical pickup 1 configured as shown in FIG. 8. In the present embodiment, the optical recording medium 2 (2a) has a shape of a disk, and is contained in a protective case 93. The optical recording medium 2 (2a) is inserted in the optical information processing apparatus 91 together with the protective case 93 via an insertion hole 94 in a direction indicated by an arrow. Then, the optical recording medium 2 is rotated by a spindle motor 95, and recording, reproduction or deletion of information is carried out on the optical recording medium 2 by means of the optical pickup 1. The optical recording medium 2 (2a) should not be necessarily contained in the protective case 93, and may be handled in a bare state instead.

By applying the above-described configuration according to the present invention to the objective lens 4 or the optical pickup 1, it is possible to obtain a satisfactory spot at any information recording surface position of the multi-layer optical recording medium 2a.

Further, the present invention is not limited to the above-described embodiments, and variations and modifications may be made without departing from the basic concept of the present invention claimed below.

The present application is based on Japanese Priority Application No. 2004-014721 filed on Jan. 22, 2004, the entire contents of which are hereby incorporated herein by reference.

1. An optical pickup comprising an objective lens configured to condensing and applying laser light, emitted from a light source, on an information recording surface of an optical recording medium, wherein:
in a case where the optical recording medium comprises a multi-layer optical recording medium having a plurality of information recording surfaces, the following equation is satisfied for each information recording surface x (x=1, 2, . . . ) of the multi-layer optical recording medium:

|CLx/CDx|≧1
where CDx (x=1, 2, . . . ) denotes each least squire error value (unit: λrms) of a cubic coma aberration component occurring per unit angle when the multi-layer optical recording medium is inclined; and
CLx (x=1, 2, . . . ) denotes each least squire error value (unit: λrms) of a cubic coma aberration component occurring per unit angle when the objective lens is inclined in a case where the laser light is condensed and applied to the predetermined information recording surface x of the multi-layer optical recording medium.

2. The optical pickup as claimed in claim 1, wherein:
said objective lens is set in such a manner that wavefront aberration on an information recording surface may become smaller than that on another information recording surface located nearer to the laser light applied side.

3. The optical pickup as claimed in claim 1, comprising:
a spherical aberration correcting part changing an imaging magnification of the objective lens according to a difference in a thickness up to each information recording surface of the multi-layer optical recording medium.

4. The optical pickup as claimed in claim 3, wherein:
said spherical aberration correcting part comprises an auxiliary lens group including a positive lens and a negative lens on a light path direction between the light source and the objective lens, and lens separation between the auxiliary lens group is changed in the optical axis direction according to the difference in the thickness up to each information recording surface of the optical recording medium.

5. The optical pickup as clamed in claim 3, wherein:
said spherical aberration correcting part comprises a coupling lens on a light path between the light source and the objective lens, and said coupling lens is moved in an optical axis direction according to the difference in the thickness up to each information recording surface of the optical recording medium.

6. The optical pickup as claimed in claim 1, comprising:
a driving part configured to incline the objective lens in at least one of a radial direction and a rotating direction of the optical recording medium.

7. The optical pickup as claimed in claim 6, comprising:
an angle detecting part detecting at least two angles from among relative angles A, B and C, where:
the relative angle A denotes a relative angle between the optical recording medium and the objective lens;
the relative angle B denotes a relative angle between the optical recording medium and a predetermined reference surface of the optical pickup; and
the relative angle C denotes a relative angle between the objective lens and the predetermined reference surface of the optical pickup.

8. The optical pickup as clamed in claim 7, comprising:
a correcting part configured to provide a predetermined gain or offset to a signal of at least one of the relative angles A, B and C according to the difference in the thickness up to each information recording surface of the multi-layer optical recording medium.

9. The optical pickup as clamed in claim 7, comprising:
a spherical aberration detecting part configured to detect a spherical aberration occurring according to the difference in the thickness up to each information recording surface of the multi-layer optical recording medium; and
a correcting part configured to provide a predetermined gain or offset to a signal of at least one of the relative angles A, B and C according to a detection signal output from said spherical aberration detecting part.

10. The optical pickup as clamed in claim 7, comprising:
a thickness detecting part configured to detect the difference in the thickness up to each information recording surface of the multi-layer optical recording medium; and
a correcting part configured to provide a predetermined gain or offset to a signal of at least one of the relative angles A, B and C according to a detection signal output from said thickness detecting part.

11. The optical pickup as claimed in claim 6, comprising:
a coma aberration detecting part configured to detect cubic coma aberration occurring according to the relative angle between the optical recording medium and the objective lens.

12. The optical pickup as claimed in claim 6, wherein:
said lens driving part undergoes initial inclination adjustment with respect to the information recording surface which is one having a maximum value of CLx.

13. An optical information processing apparatus carrying out recording information to, reproduction or deletion of information from an optical recording medium with the use of the optical pickup claimed in claim 1.

14. An optical information processing apparatus carrying out recording information to, reproduction or deletion of information from an optical recording medium with the use of the optical pickup claimed in claim 2.

15. An optical information processing apparatus carrying out recording information to, reproduction or deletion of information from an optical recording medium with the use of the optical pickup claimed in claim 3.

16. An optical information processing apparatus carrying out recording information to, reproduction or deletion of information from an optical recording medium with the use of the optical pickup claimed in claim 4.

17. An optical information processing apparatus carrying out recording information to, reproduction or deletion of information from an optical recording medium with the use of the optical pickup claimed in claim 5.

18. An optical information processing apparatus carrying out recording information to, reproduction or deletion of information from an optical recording medium with the use of the optical pickup claimed in claim 6.

19. An optical information processing apparatus carrying out recording information to, reproduction or deletion of information from an optical recording medium with the use of the optical pickup claimed in claim 7.

20. An optical information processing apparatus carrying out recording information to, reproduction or deletion of information from an optical recording medium with the use of the optical pickup claimed in claim 8.

21. An optical information processing apparatus carrying out recording information to, reproduction or deletion of information from an optical recording medium with the use of the optical pickup claimed in claim 9.

22. An optical information processing apparatus carrying out recording information to, reproduction or deletion of information from an optical recording medium with the use of the optical pickup claimed in claim 10.

23. An optical information processing apparatus carrying out recording information to, reproduction or deletion of information from an optical recording medium with the use of the optical pickup claimed in claim 11.

24. An optical information processing apparatus carrying out recording information to, reproduction or deletion of information from an optical recording medium with the use of the optical pickup claimed in claim 12.

25. An optical information processing apparatus carrying out recording information to, reproduction or deletion of information from an optical recording medium having an information recording surface produced in a range between 0.54 and 0.63 mm from an incident surface of the optical recording medium, with the use of the optical pickup claimed in claim 1.

26. An optical information processing apparatus carrying out recording information to, reproduction or deletion of information from an optical recording medium having an information recording surface produced in a range between 0.54 and 0.63 mm from an incident surface of the optical recording medium, with the use of the optical pickup claimed in claim 2.

27. An optical information processing apparatus carrying out recording information to, reproduction or deletion of information from an optical recording medium having an information recording surface produced in a range between 0.54 and 0.63 mm from an incident surface of the optical recording medium, with the use of the optical pickup claimed in claim 3.

28. An optical information processing apparatus carrying out recording information to, reproduction or deletion of information from an optical recording medium having an information recording surface produced in a range between 0.54 and 0.63 mm from an incident surface of the optical recording medium, with the use of the optical pickup claimed in claim 4.

29. An optical information processing apparatus carrying out recording information to, reproduction or deletion of information from an optical recording medium having an information recording surface produced in a range between 0.54 and 0.63 mm from an incident surface of the optical recording medium, with the use of the optical pickup claimed in claim 5.

30. An optical information processing apparatus carrying out recording information to, reproduction or deletion of information from an optical recording medium having an information recording surface produced in a range between 0.54 and 0.63 mm from an incident surface of the optical recording medium, with the use of the optical pickup claimed in claim 6.

31. An optical information processing apparatus carrying out recording information to, reproduction or deletion of information from an optical recording medium having an information recording surface produced in a range between 0.54 and 0.63 mm from an incident surface of the optical recording medium, with the use of the optical pickup claimed in claim 7.

32. An optical information processing apparatus carrying out recording information to, reproduction or deletion of information from an optical recording medium having an information recording surface produced in a range between 0.54 and 0.63 mm from an incident surface of the optical recording medium, with the use of the optical pickup claimed in claim 8.

33. An optical information processing apparatus carrying out recording information to, reproduction or deletion of information from an optical recording medium having an information recording surface produced in a range between 0.54 and 0.63 mm from an incident surface of the optical recording medium, with the use of the optical pickup claimed in claim 9.

34. An optical information processing apparatus carrying out recording information to, reproduction or deletion of information from an optical recording medium having an information recording surface produced in a range between 0.54 and 0.63 mm from an incident surface of the optical recording medium, with the use of the optical pickup claimed in claim 10.

35. An optical information processing apparatus carrying out recording information to, reproduction or deletion of information from an optical recording medium having an information recording surface produced in a range between 0.54 and 0.63 mm from an incident surface of the optical recording medium, with the use of the optical pickup claimed in claim 11.

36. An optical information processing apparatus carrying out recording information to, reproduction or deletion of information from an optical recording medium having an information recording surface produced in a range between 0.54 and 0.63 mm from an incident surface of the optical recording medium, with the use of the optical pickup claimed in claim 12.

37. An optical information processing method for carrying out recording information to, reproduction or deletion of information from an optical recording medium having an information recording surface produced in a range between 0.54 and 0.63 mm from an incident surface of the optical recording medium, with the use of the optical pickup claimed in claim 1.

38. An optical information processing method for carrying out recording information to, reproduction or deletion of information from an optical recording medium having an information recording surface produced in a range between 0.54 and 0.63 mm from an incident surface of the optical recording medium, with the use of the optical pickup claimed in claim 2.

39. An optical information processing method for carrying out recording information to, reproduction or deletion of information from an optical recording medium having an information recording surface produced in a range between 0.54 and 0.63 mm from an incident surface of the optical recording medium, with the use of the optical pickup claimed in claim 3.

40. An optical information processing method for carrying out recording information to, reproduction or deletion of information from an optical recording medium having an information recording surface produced in a range between 0.54 and 0.63 mm from an incident surface of the optical recording medium, with the use of the optical pickup claimed in claim 4.

41. An optical information processing method for carrying out recording information to, reproduction or deletion of information from an optical recording medium having an information recording surface produced in a range between 0.54 and 0.63 mm from an incident surface of the optical recording medium, with the use of the optical pickup claimed in claim 5.

42. An optical information processing method for carrying out recording information to, reproduction or deletion of information from an optical recording medium having an information recording surface produced in a range between 0.54 and 0.63 mm from an incident surface of the optical recording medium, with the use of the optical pickup claimed in claim 6.

43. An optical information processing method for carrying out recording information to, reproduction or deletion of information from an optical recording medium having an information recording surface produced in a range between 0.54 and 0.63 mm from an incident surface of the optical recording medium, with the use of the optical pickup claimed in claim 7.

44. An optical information processing method for carrying out recording information to, reproduction or deletion of information from an optical recording medium having an information recording surface produced in a range between 0.54 and 0.63 mm from an incident surface of the optical recording medium, with the use of the optical pickup claimed in claim 8.

45. An optical information processing method for carrying out recording information to, reproduction or deletion of information from an optical recording medium having an information recording surface produced in a range between 0.54 and 0.63 mm from an incident surface of the optical recording medium, with the use of the optical pickup claimed in claim 9.

46. An optical information processing method for carrying out recording information to, reproduction or deletion of information from an optical recording medium having an information recording surface produced in a range between 0.54 and 0.63 mm from an incident surface of the optical recording medium, with the use of the optical pickup claimed in claim 10.

47. An optical information processing method for carrying out recording information to, reproduction or deletion of information from an optical recording medium having an information recording surface produced in a range between 0.54 and 0.63 mm from an incident surface of the optical recording medium, with the use of the optical pickup claimed in claim 11.

48. An optical information processing method for carrying out recording information to, reproduction or deletion of information from an optical recording medium having an information recording surface produced in a range between 0.54 and 0.63 mm from an incident surface of the optical recording medium, with the use of the optical pickup claimed in claim 12.
